(19) United States
(12) Patent Application Publication
(10) Pub. No.: US 2025/0218156 A1
(43) Pub. Date: Jul. 3, 2025

(54) METHOD FOR UPDATING BOUNDING BOX OR KEYPOINT IN OBJECT DETECTION MODEL

(71) Applicant: INDUSTRIAL TECHNOLOGY RESEARCH INSTITUTE, Hsinchu (TW)

(72) Inventors: Jing-Yao CHEN, Tainan City (TW); San-Chang ZHANG, Hsinchu City (TW); Po-Yuan SHIH, Taipei City (TW); Shang-Hua LIAO, Hsinchu County (TW)

(73) Assignee: INDUSTRIAL TECHNOLOGY RESEARCH INSTITUTE, Hsinchu (TW)

(21) Appl. No.: 18/749,066

(22) Filed: Jun. 20, 2024

(30) Foreign Application Priority Data
Dec. 29, 2023 (TW) 112151495

(51) Int. Cl. G06V 10/764; G06T 7/136; G06T 7/174

(52) U.S. Cl. CPC G06V 10/764; G06T 7/136; G06T 7/174; G06T 2210/12

(57) ABSTRACT

A method for updating a bounding box or a keypoint in an object detection model is provided. The method for updating the bounding box in the object detection model is performed by a computing device and includes the followings. Inputting a video to the object detection model, wherein the video includes a plurality of previous frames and a current frame. Detecting an object in the current frame by the object detection model and outputting a current bounding box and a confidence value associated with the object. When the confidence value is less than a threshold, updating the current bounding box according to the plurality of previous frames, the current frame, and a motion vector. The motion vector is associated with one of the plurality of previous frames and the current frame.

### CROSS-REFERENCE TO RELATED APPLICATIONS

This non-provisional application claims priority under 35 U.S.C. § 119(a) on Patent Application No(s). 112151495 filed in Taiwan on Dec. 29, 2023, the entire contents of which are hereby incorporated by reference.

### BACKGROUND

### 1. Technical Field

The present disclosure relates to object recognition and artificial intelligence models, particularly to a method for updating bounding box or keypoint in an object detection model.

### 2. Related Art

Artificial Intelligence (AI) models for multi-object recognition or keypoint recognition have high complexity. Early Exit is a commonly used method to shorten the inference time of AI models. Confidence values for objects are outputted in the intermediate layer of the model, and if the confidence values exceed a threshold, the results may be output early. There are some discussions related to an object detection model that enhances the accuracy of real-time inference while achieving a balance between speed and accuracy.

### SUMMARY

According to one or more embodiment of the present disclosure, a method for updating a bounding box in an object detection model is provided. The method is performed by a computing device and comprises: inputting a video to the object detection model, wherein the video includes a plurality of previous frames and a current frame; detecting an object in the current frame by the object detection model and outputting a current bounding box and a confidence value associated with the object; and when the confidence value is less than a threshold, updating the current bounding box according to the plurality of previous frames, the current frame, and a motion vector, wherein the motion vector is associated with one of the plurality of previous frames and the current frame.

According to one or more embodiment of the present disclosure, a method for updating a keypoint in an object detection model is provided. The method is performed by a computing device and comprises: inputting a video to the object detection model, wherein the video includes a plurality of previous frames and a current frame; detecting an object in the current frame by the object detection model and outputting a plurality of keypoints and a plurality of confidence values associated with the object, wherein a candidate point of the plurality of keypoints corresponds to a candidate confidence value of the plurality of confidence values; and when the candidate confidence value is less than a threshold, updating the candidate point according to the plurality of previous frames, the current frame, and a motion vector, wherein the motion vector is associated with one of the plurality of previous frames and the current frame.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is an architectural diagram of a feature compensation procedure and an object detection model;

FIG. 2 is a flowchart of a method for updating a bound box in an object detection model according to an embodiment of the present disclosure;

FIG. 3 is a schematic diagram of a motion vector;

FIG. 4 is a flowchart of the feature compensation procedure according to one or more embodiments of the present disclosure;

FIG. 5 is a flowchart of the motion vector prediction procedure (for the bounding box) according to an embodiment of the present disclosure;

FIG. 6 is a flowchart of a method for updating a keypoint in an object detection model according to an embodiment of the present disclosure;

FIG. 7 is a flowchart of the motion vector prediction procedure (for the keypoint) according to an embodiment of the present disclosure; and

FIG. 8 is a schematic diagram of an example of a moving box.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

The present disclosure proposes a method for updating a bounding box in an object detection model. This method is performed by a computing device. In an embodiment, the computing device may include a central processing unit (CPU), a graphics processing unit (GPU), a microcontroller (MCU), an application processor (AP), a field-programmable gate array (FPGA), an Application Specific Integrated Circuit (ASIC), a digital signal processor (DSP), a system-on-a-chip (SOC), or a deep learning accelerator. However, the present disclosure is not limited to these examples.

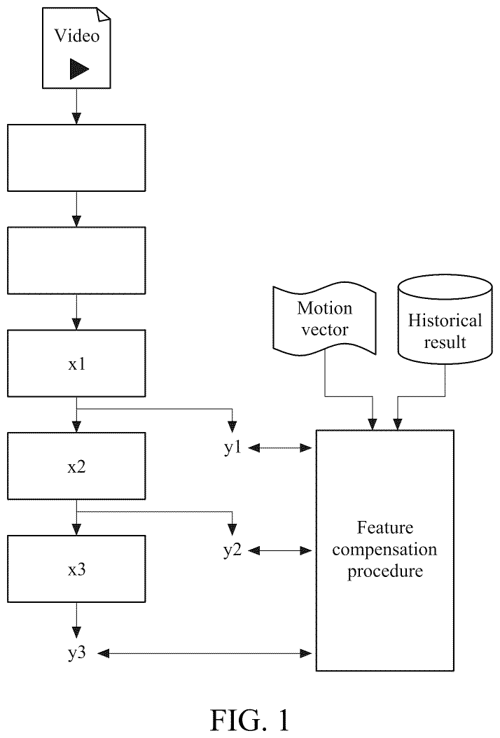

The method for updating the bounding box in the object detection model in the present disclosure includes a feature compensation procedure in the object detection model applying the Early Exit technique. Please refer to FIG. 1. FIG. 1 is an architectural diagram of the feature compensation procedure and the object detection model. As shown in FIG. 1, the input to the object detection model can be video captured in real-time by a camera, recorded video files, or any video, video stream, or video file. The present disclosure is not limited thereof. The object detection model may use, for example, a neural network including a plurality of intermediate layers x1, x2, x3. The outputs y1, y2, y3 of each intermediate layer include a plurality of bounding boxes and their confidence values. Each bounding box is configured to frame an object of a specific category, and the confidence value represents the probability that the object belongs to that specific category. In an embodiment, if the confidence values of all bounding boxes output by a certain intermediate layer (such as x1) exceed a threshold, these bounding boxes can be output to early exit the object detection model. In an embodiment, the object detection model does not exit early as long as the confidence value of at least one bounding box is below the threshold.

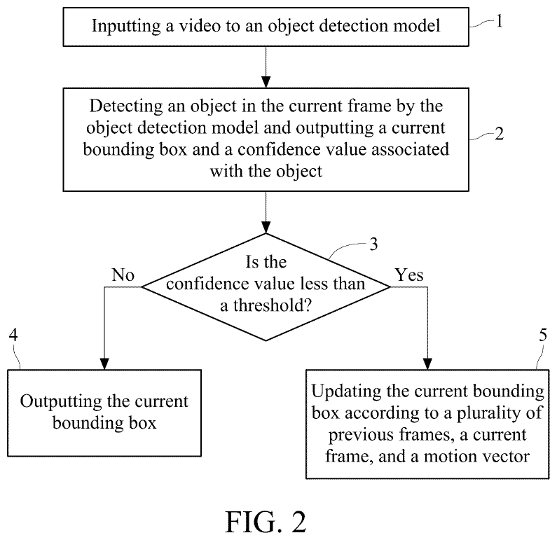

In an embodiment, for the bounding box with confidence value not exceeding the threshold, a feature compensation procedure is introduced to adjust the original bounding box. The feature compensation procedure, for example, refers to motion vectors and historical results. Please refer to FIG. 2. FIG. 2 is a flowchart of the method for updating the bound box in the object detection model according to an embodiment of the present disclosure.

In step 1, a video is inputted to the object detection model, wherein the video includes a plurality of previous frames and a current frame.

In step 2, the object detection model detects an object in the current frame and outputs a current bounding box and a confidence value associated with the object. As mentioned earlier, this step is performed in one of the intermediate layers of the object detection model.

In step 3, the computing device determines if the confidence value is less than a threshold. If the determined result is false, the method proceeds to step 4 and outputs the current bounding box. If the determined result is true, the method proceeds to step 5 and executes the feature compensation procedure.

In step 5, when the confidence value is less than the threshold, the computing device updates the current bounding box according to the plurality of previous frames, the current frame, and a motion vector. In an embodiment, step 5 corresponds to the aforementioned feature compensation procedure, where the input includes the plurality previous frames, the current frame, and the motion vector, and the output is the updated current bounding box.

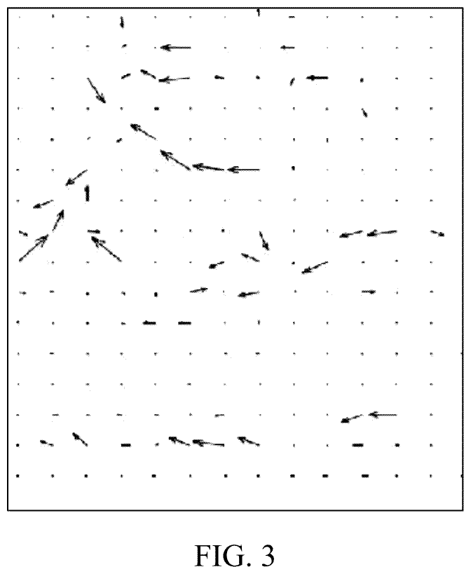

The motion vector is associated with one of the plurality of previous frames and the current frame. In an embodiment, assuming five frames from first to last in time order are A, B, C, D, and E, where A, B, C, and D are the previous frames, E is the current frame, and D is the previous frame adjacent to the current frame, the motion vector is calculated according to D and E. Since the motion vector can be automatically generated during video decoding, there is no or little additional time cost. Please refer to FIG. 3. FIG. 3 is a schematic diagram of a motion vector.

The motion vector is used in video compression coding. In video compression design, there are three types of frames: I-frame (Intra-coded picture), P-frame (Predicted picture), and B-frame (Bidirectional predicted picture or Bi-directional pictures). I-frame is a complete frame that do not depend on data from other frames. P-frame is predicted according to one or more previous frames and use a motion compensation technique to describe the differences between the P-frame and the reference frame. These differences are represented using motion vectors and residual data. B-frame is predicted according to both previous and subsequent frames. Therefore, there are two motion vectors-one pointing to the previous reference frame and the other to the subsequent reference frame.

Therefore, the motion vector is generated when the current frame belongs to the P-frame or B-frame. In an embodiment, if the current frame belongs to the I-frame and requires a compensation procedure, the motion vector may be extracted by inputting the current frame and the previous frame to an API (Application Programming Interface), for example, the NVIDIA Optical Flow SDK.

In an embodiment, the input of the feature compensation procedure includes the plurality of previous frames A, B, C, D, the current frame E, and the motion vector. Based on whether each previous frame includes the bounding box associated with the object, there are six scenarios as shown in Table 1 below.

TABLE 1

| | A | B | C | D |
|---|---|---|---|---|
| Scenario 1 | Yes | Yes | Yes | Yes |
| Scenario 2 | No | Yes | Yes | Yes |
| Scenario 3 | Yes | Yes | No | Yes |
| Scenario 4 | Yes | No | Yes | Yes |
| Scenario 5 | Yes | Yes | Yes | No |
| Scenario 6 | No | No | No | Yes |

In Table 1, the field marked “Yes” indicates that the previous frame has a bounding box associated with the object, while the field marked “No” indicates that the previous frame lacks a bounding box associated with the object.

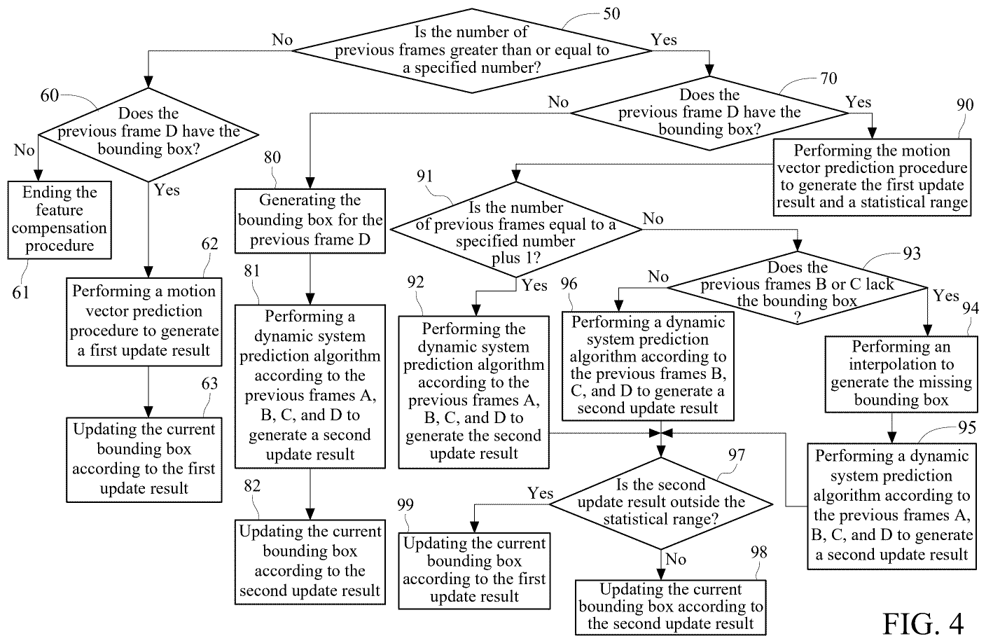

FIG. 4 is a flowchart of the feature compensation procedure according to one or more embodiments of the present disclosure. Performing the corresponding steps in FIG. 4 according to any of the scenarios in Table 1 may be an embodiment of the feature compensation procedure.

In step 50, the computing device determines whether the number of previous frames is greater than or equal to a specified number or not. If the determined result is false, the method proceeds to step 60. If the determined result is true, the method proceeds to step 70. In an embodiment, the specified number is 3.

In step 60, the computing device determines whether the previous frame D has a bounding box associated with the object or not. If the determined result is false, the method proceeds to step 61. If the determined result is true, the method proceeds to step 62. In step 61, the computing device ends the feature compensation procedure as there are not enough historical results for feature compensation. In step 62, the computing device performs a motion vector prediction procedure according to the bounding box of the previous frame D and the motion vector to generate a first update result. Then, the method proceeds to step 63 to update the current bounding box according to the first update result.

Scenario 6 of Table 1 can proceed to step 63. In detail, the plurality of previous frames comprises a first frame D preceding the current frame E. When the number of the plurality of previous frames is less than a specified number and the first frame D has a first bounding box associated with the object, the motion vector prediction procedure is performed according to the first bounding box and the motion vector to update the current bounding box.

In step 70, the computing device determines whether the previous frame D has a bounding box associated with the object or not. If the determined result is false, the method proceeds to step 80. If the determined result is true, the method proceeds to step 90.

In step 80, the bounding boxes of the previous frames A, B, and C are inputted to a dynamic system prediction algorithm to generate the bounding box for the previous frame D. In an embodiment, the dynamic system prediction algorithm adopts the Kalman filter. Then, the method proceeds to step 81 and the computing device performs the dynamic system prediction algorithm according to the previous frames A, B, C, and D to generate a second update result. Then, the method proceeds to step 82 and the computing devices update the current bounding box according to the second update result.

Scenario 5 of Table 1 can proceed to step 82. In detail, the plurality of previous frames comprises a first frame D preceding the current frame E and a plurality of historical frames preceding the first frame D. The plurality of historical frames comprises a second frame C preceding the first frame D, a third frame B preceding the second frame C, and a fourth frame A preceding the third frame B, where the second frame C, the third frame B, and the fourth frame A each have a second bounding box, a third bounding box, and a fourth bounding box associated with the object, and updating the current bounding box according to the plurality of previous frames, the current frame, and the motion vector comprises: when the number of the plurality of previous frames is not less than the specified number and the first frame D lacks the first bounding box associated with the object, performing the dynamic system prediction algorithm according to a plurality of historical bounding boxes associated with the object in the plurality of historical frames to update the current bounding box. Performing the dynamic system prediction algorithm according to the plurality of historical bounding boxes associated with the object in the plurality of historical frames to update the current bounding box comprises: performing the dynamic system prediction algorithm according to the second bounding box, the third bounding box, and the fourth bounding box to generate the first bounding box, and performing the dynamic system prediction algorithm according to the first bounding box, the second bounding box, the third bounding box, and the fourth bounding box to update the current bounding box.

In step 90, the motion vector prediction procedure is performed according to the previous frame D to generate the first update result and a statistical range.

In step 91, the computing device determines whether the number of previous frames is equal to the specified number plus 1. In an embodiment, the specified number is 3. Therefore, in step 91, the computing device determines whether 4 previous frames have been collected or not. If the determined result is true, the method proceeds to step 92. If the determined result is false, the method proceeds to step 93.

In step 92, the dynamic system prediction algorithm is performed according to the previous frames A, B, C, and D to generate the second update result. Scenario 1 of Table 1 can proceed to step 92. After completing step 92, the method proceeds to step 97.

In step 93, the computing device determines whether the previous frames B or C lack the bounding box or not. If the determined result is false, the method proceeds to step 96. If the determined result is true, the method proceeds to step 94.

In step 94, the computing device performs an interpolation to generate the missing bounding box. If the previous frame lacking a bounding box is B, the interpolation is performed according to the previous frames A, C, and D to generate the bounding box corresponding to the previous frame B. If the previous frame lacking the bounding box is C, the interpolation is performed according to the previous frames A, B, and D to generate the bounding box corresponding to the previous frame C. After completing step 94, the method proceeds to step 95 and perform the dynamic system prediction algorithm according to the previous frames A, B, C, and D to generate the second update result.

Scenario 2 of Table 1 can proceed to step 95. In detail, the plurality of historical frames comprises: a second frame C preceding the first frame D, a third frame B preceding the second frame C, and a fourth frame A preceding the third frame B. Performing the dynamic system prediction algorithm according to the plurality of historical bounding boxes associated with the object in the historical frames to generate the second update result comprises: when the second frame C has a second bounding box associated with the object and the third frame B has a third bounding box associated with the object, performing the dynamic system prediction algorithm according to the second bounding box, the third bounding box, and a fourth bounding box associated with the object in the fourth frame to generate the second update result.

In step 96, the computing device performs the dynamic system prediction algorithm according to the previous frames B, C, and D to generate the second update result.

Scenarios 3 or 4 of Table 1 can proceed to step 96. In detail, updating the current bounding box according to the plurality of previous frames, the current frame, and the motion vector comprises: when the number of plurality of previous frames is not less than the specified number and the first frame has the first bounding box associated with the object, performing the motion vector prediction procedure according to the first bounding box and the motion vector to generate the first update result and the statistical range; performing the dynamic system prediction algorithm according to the plurality of historical bounding boxes associated with the object in the plurality of historical frames to generate the second update result.

Performing the dynamic system prediction algorithm according to the plurality of historical bounding boxes associated with the object in the plurality of historical frames to generate the second update result comprises: when one of the second frame C and the third frame B lacks the bounding box associated with the object, performing the interpolation according to the first bounding box associated with the object in the first frame D, a second bounding box associated with the object in the second frame C or a third bounding box associated with the object in the third frame B, and a fourth bounding box associated with the object in the fourth frame A to generate the bounding box; and performing the dynamic system prediction algorithm according to the first bounding box, the second bounding box, the third bounding box, and the fourth bounding box to generate the second update result.

In step 97, the computing device determines whether the second update result is outside the statistical range or not. If the determined result is false, the method proceeds to step 98 to update the current bounding box according to the second update result. If the determined result is true, the method proceeds to step 99 to update the current bounding box according to the first update result.

In an embodiment, the second update result is a new bounding box. The statistical range includes at least a first interval and a second interval, with each interval comprising a first range corresponding to the X-axis and a second range corresponding to the Y-axis. In an embodiment, if the top-left corner coordinates of the second update result are outside the first interval (the X-coordinate is outside the first range, and the Y-coordinate is outside the second range), and the bottom-right corner coordinates of the second update result are outside the second interval, then the determined result is true. Conversely, if the top-left corner coordinates of the second update result are inside the first interval (the X-coordinate is inside the first range, and the Y-coordinate is inside the second range), and the bottom-right corner coordinates of the second update result are inside the second interval, then the determined result is false.

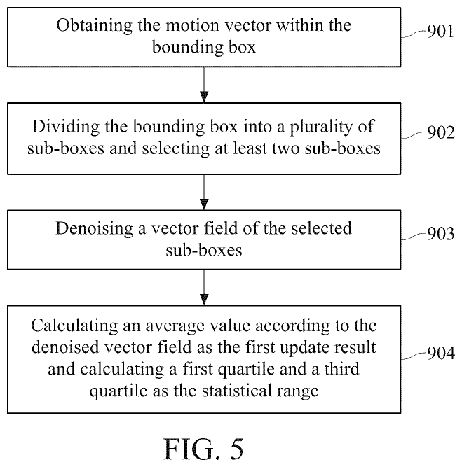

The motion vector prediction procedure may refer to FIG. 5. FIG. 5 is a flowchart of the motion vector prediction procedure, for example, for the bounding box according to an embodiment of the present disclosure.

In step 901, the computing device obtains the motion vector within the bounding box. In an embodiment, the bounding box of the previous frame D is rectangular. Based on the coordinates of the two vertices, the top-left and bottom-right, the motion vectors in the area of the bounding box may be obtained from the moving vector map, as shown in FIG. 3.

In step 902, the computing device divides the bounding box into a plurality of sub-boxes and select at least two of the plurality of sub-boxes. In an embodiment, perform the division in 2×2 format and select the top-left and bottom-right sub-boxes. The number of sub-boxes for division is not limited, for example, the bounding box may also be divided into 3×3 format. The selection of sub-boxes may use a diagonal form. In other embodiments, the bottom-left and top-right sub-boxes can be selected.

In step 903, the computing device denoises a vector field of the selected at least two sub-boxes. The vector field corresponds to the motion vectors of all pixels in the selected at least two sub-boxes. In an embodiment, denoising refers to retaining the motion vectors within the average plus or minus one standard deviation. However, the present disclosure does not limit the denoising calculation method to the example given above.

In step 904, the computing device calculates an average value according to the denoised vector field as the first update result and calculate a first quartile and a third quartile as the statistical range. The first update result is a new bounding box. In an embodiment, the coordinates of the top-left vertex of the first update result are the average of the remaining motion vectors in the top-left sub-box, and the coordinates of the bottom-right vertex of the first update result are the average of the remaining motion vectors in the bottom-right sub-box. The statistical range is composed of the first quartile (Q1) and the third quartile (Q3) calculated from the remaining motion vectors. However, the present disclosure is not limited to the average or quartiles mentioned above. Additionally, the step of calculating the statistical range can be omitted in the motion vector prediction procedure performed in step 62.

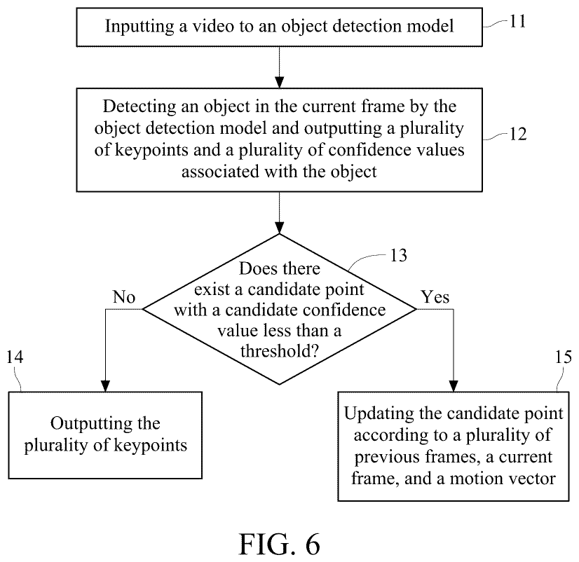

The feature compensation procedure proposed in the present disclosure is not only applicable to bounding boxes but also to keypoints. In an embodiment, when the object to be detected by the object detection model is a human body, its trunk and limbs can be represented in a skeletal form, and the starting and ending points of each line segment composing the skeleton may be keypoints. Please refer to FIG. 6. FIG. 6 is a flowchart of a method for updating a keypoint in an object detection model according to an embodiment of the present disclosure. The method includes steps 11 to 15 performed by a computing device as shown in FIG. 6.

In step 11, a video is inputted to the object detection model, wherein the video includes a plurality of previous frames and a current frame.

In step 12, the object detection model detects an object in the current frame and outputs a plurality of keypoints and a plurality of confidence values associated with the object. The plurality of keypoints are in a one-to-one correspondence with the plurality of confidence values.

In step 13, among the plurality of keypoint, the computing device determines whether there exists a candidate point with a candidate confidence value less than a threshold or not. If the determined result is false, the method proceeds to step 14. If the determined result is true, the method proceeds to step 15. The candidate point represents one of the plurality of keypoints. The candidate confidence value represents one of the plurality of confidence values and corresponds to the candidate point.

If the candidate confidence values of each candidate point are all not less than the threshold, step 14 is performed to output the plurality of keypoints.

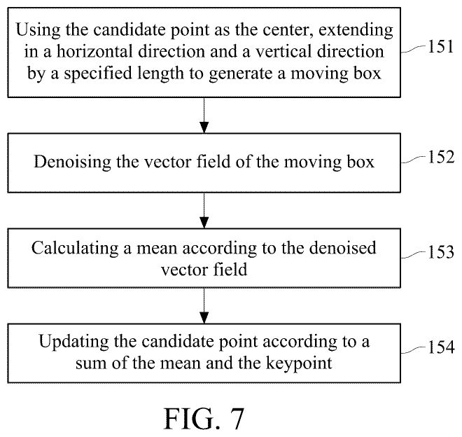

If there exists a candidate point with a candidate confidence value less than the threshold, step 15 is performed to update the candidate point according to the plurality of previous frames, the current frame, and a motion vector. In an embodiment, the bounding boxes in the flowchart of FIG. 4 may be adaptively adjusted to the keypoints, thereby obtaining a feature compensation procedure applicable to keypoints. As for the motion vector prediction procedure, it can be modified as shown in FIG. 7.

FIG. 7 is a flowchart of the motion vector prediction procedure (for the keypoint) according to an embodiment of the present disclosure.

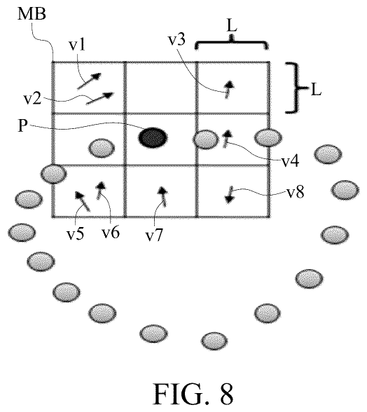

In step 151, the computing device uses the candidate point as the center, extends in a horizontal direction and a vertical direction by a specified length to generate a moving box (MB). FIG. 8 is a schematic diagram of an example of the moving box. FIG. 8 presents the candidate point P and the plurality of keypoints (unlabeled) around the candidate point P. In an embodiment, the specified length is 16 pixels. The moving box is a rectangle centered on the candidate point P and extending 16 pixels up, down, left and right, as shown in the moving box MB in FIG. 8.

In step 152, the computing device denoises the vector field of the moving box. In an embodiment, calculate the mean and standard deviation according to the motion vectors within the moving box MB. The motion vectors are represented by arrows v1-v8 in FIG. 8. The calculations of the mean (mean(dx, dy)) and standard deviation (std(dx, dy)) are shown in Equations 1 and 2, respectively, where N=8.

$$mean ( dx , dy ) = \frac{1}{N} {\sum }_{i = 0}^{N} {v}_{i} \qquad ( Equation 1 )$$

$$std ( dx , dy ) = \sqrt{\frac{1}{N} {{\sum }_{i = 0}^{N} [ {v}_{i} - mean ( dx , dy ) ]}^{2}} \qquad ( Equation 2 )$$

Denoising refers to retaining the motion vectors within the average plus or minus one standard deviation. In other words, the motion vectors beyond one standard deviation is excluded, as shown in the following Equation 3, where mv represents the set of motion vectors after denoising. In the example of FIG. 8, vector v8 would be excluded.

$$mv ∈ \{ ( dx , dy ) \vert mean ( dx , dy ) \pm std ( dx , dy ) \} \qquad ( Equation 3 )$$

In step 153, the computing device calculates the mean (mean′(dx, dy)) according to the denoised vector field as shown in Equation 4 below.

$${mean}^{′} ( dx , dy ) = \frac{1}{N} ( {\sum }_{i = 0}^{N} {v}_{i} - {v}_{8} ) \qquad ( Equation 4 )$$

In step S154, the computing device updates the candidate point according to a sum of the mean (mean′(dx, dy)) and the keypoint (old_keypoint(x, y)), as shown in Equation 5 below, where new_keypoint(x, y) represents the updated candidate point.

$$new\_keypoint ( x , y ) = old\_keypoint ( x , y ) + mean ( dx , dy ) \qquad ( Equation 5 )$$

The plurality of embodiments shown in FIG. 4 are based on the feature compensation procedure for the bounding box. Those skilled in the art to which the present disclosure pertains may replace the current bounding box mentioned in the embodiments of FIG. 4 with the candidate point mentioned in FIG. 6 and FIG. 8. They can also replace the first through fourth bounding boxes with the first through fourth keypoints, thereby implementing the feature compensation procedure based on keypoints. Therefore, a detailed explanation of the feature compensation procedure in the method of updating the keypoint in the object detection model is not repeated here.

The computational speed of the present disclosure is fast. In terms of accuracy, the present disclosure demonstrates stable performance while maintaining a high level of precision. Moreover, the preset disclosure is less sensitive to changes in the number of frames.

In summary, the present disclosure proposes a method for updating the bounding box or keypoint in an object detection model, which can improve the architecture of neural network applications for early exit techniques. The present disclosure is applicable to various fields, such as multi-object detection or keypoint tracking. The feature compensation procedure proposed by the present disclosure can enhance the accuracy of real-time inference, making the object detection model both fast and accurate. In an experiment, the inference speed of the object detection model applying the present disclosure increased from the traditional 14 frames per second to 55 frames per second, and the mean average precision (mAP) improved from the original 47.8 to 53.1.

The foregoing description, for the purpose of explanation, has been described with reference to specific embodiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings. For the defined scope of protection of the present disclosure, please refer to the appended claims.

What is claimed is:

1. A method for updating a bounding box in an object detection model, wherein the method is performed by a computing device and comprises:
inputting a video to the object detection model, wherein the video includes a plurality of previous frames and a current frame;
detecting an object in the current frame by the object detection model and outputting a current bounding box and a confidence value associated with the object; and
when the confidence value is less than a threshold, updating the current bounding box according to the plurality of previous frames, the current frame, and a motion vector, wherein the motion vector is associated with one of the plurality of previous frames and the current frame.

2. The method for updating the bounding box in the object detection model of claim 1, wherein the plurality of previous frames comprises a first frame preceding the current frame, and updating the current bounding box according to the plurality of previous frames, the current frame, and the motion vector comprises:
when a number of the plurality of previous frames is less than a specified number and the first frame has a first bounding box associated with the object, performing a motion vector prediction procedure according to the first bounding box and the motion vector to update the current bounding box.

3. The method for updating the bounding box in the object detection model of claim 1, wherein the plurality of previous frames comprises a first frame preceding the current frame and a plurality of historical frames preceding the first frame, and updating the current bounding box according to the plurality of previous frames, the current frame, and the motion vector comprises:
when a number of the plurality of previous frames is not less than a specified number and the first frame lacks a first bounding box associated with the object, performing a dynamic system prediction algorithm according to a plurality of historical bounding boxes associated with the object in the plurality of historical frames to update the current bounding box.

4. The method for updating the bounding box in the object detection model of claim 3, wherein the plurality of historical frames comprises: a second frame preceding the first frame, a third frame preceding the second frame, and a fourth frame preceding the third frame, and wherein the second frame, the third frame, and the fourth frame each have a second bounding box, a third bounding box, and a fourth bounding box associated with the object, and performing the dynamic system prediction algorithm according to the plurality of historical bounding boxes associated with the object in the plurality of historical frames to update the current bounding box comprises:
performing the dynamic system prediction algorithm according to the second bounding box, the third bounding box, and the fourth bounding box to generate the first bounding box; and
performing the dynamic system prediction algorithm according to the first bounding box, the second bounding box, the third bounding box, and the fourth bounding box to update the current bounding box.

5. The method for updating the bounding box in the object detection model of claim 1, wherein the plurality of previous frames comprises a first frame preceding the current frame and a plurality of historical frames preceding the first frame, and updating the current bounding box according to the plurality of previous frames, the current frame, and the motion vector comprises:
when a number of the plurality of previous frames is not less than a specified number and the first frame has a first bounding box associated with the object, performing a motion vector prediction procedure according to the first bounding box and the motion vector to generate a first update result and a statistical range;
performing a dynamic system prediction algorithm according to a plurality of historical bounding boxes associated with the object in the plurality of historical frames to generate a second update result;
when the second update result is outside the statistical range, updating the current bounding box according to the first update result; and
when the second update result is within the statistical range, updating the current bounding box according to the second update result.

6. The method for updating the bounding box in the object detection model of claim 5, wherein the plurality of historical frames comprises: a second frame preceding the first frame, a third frame preceding the second frame, and a fourth frame preceding the third frame; and performing the dynamic system prediction algorithm according to the plurality of historical bounding boxes associated with the object in the plurality of historical frames to generate the second update result comprises:
when one of the second frame and the third frame lacks a bounding box associated with the object, performing an interpolation according to the first bounding box associated with the object in the first frame, a second bounding box associated with the object in the second frame or a third bounding box associated with the object in the third frame, and a fourth bounding box associated with the object in the fourth frame to generate the bounding box; and
performing the dynamic system prediction algorithm according to the first bounding box, the second bounding box, the third bounding box, and the fourth bounding box to generate the second update result.

7. The method for updating the bounding box in the object detection model of claim 5, wherein the plurality of historical frames comprises: a second frame preceding the first frame, a third frame preceding the second frame, and a fourth frame preceding the third frame, and performing the dynamic system prediction algorithm according to the plurality of historical bounding boxes associated with the object in the historical frames to generate the second update result comprises:
when the second frame has a second bounding box associated with the object and the third frame has a third bounding box associated with the object, performing the dynamic system prediction algorithm according to the second bounding box, the third bounding box, and a fourth bounding box associated with the object in the fourth frame to generate the second update result.

8. The method for updating the bounding box in the object detection model of claim 5, wherein performing the motion vector prediction procedure according to the first bounding box and the motion vector to generate the first update result and the statistical range comprises:
obtaining the motion vector within the first bounding box;
dividing the first bounding box into a plurality of sub-boxes and selecting at least two sub-boxes of the plurality of sub-boxes;
denoising a vector field of the at least two sub-boxes, wherein the vector field corresponds to the motion vector of the at least two sub-boxes; and
calculating an average value according to the denoised vector field as the first update result, and calculating a first quartile and a third quartile as the statistical range.

9. A method for updating a keypoint in an object detection model, wherein the method is performed by a computing device and comprises:
inputting a video to the object detection model, wherein the video includes a plurality of previous frames and a current frame;
detecting an object in the current frame by the object detection model and outputting a plurality of keypoints and a plurality of confidence values associated with the object, wherein a candidate point of the plurality of keypoints corresponds to a candidate confidence value of the plurality of confidence values; and
when the candidate confidence value is less than a threshold, updating the candidate point according to the plurality of previous frames, the current frame, and a motion vector, wherein the motion vector is associated with one of the plurality of previous frames and the current frame.

10. The method for updating the keypoint in the object detection model of claim 9, wherein updating the candidate point according to the plurality of previous frames, the current frame, and the motion vector comprises:
using the candidate point as the center and extending in a horizontal direction and a vertical direction by a specified length respectively to generate a moving box;
denoising a vector field of the moving box, wherein the vector field corresponds to the motion vector within the moving box;
calculating an average according to the denoised vector field; and
updating the candidate point according to a sum of the average and the keypoint.

11. The method for updating the keypoint in the object detection model of claim 9, wherein the plurality of previous frames comprises a first frame preceding the current frame, and updating the candidate point according to the plurality of previous frames, the current frame, and the motion vector comprises:
when a number of the plurality of previous frames is less than a specified number and the first frame has a first keypoint associated with the object, performing a motion vector prediction procedure according to the first keypoint and the motion vector to update the candidate point.

12. The method for updating the keypoint in the object detection model of claim 9, wherein the plurality of previous frames comprises a first frame preceding the current frame and a plurality of historical frames preceding the first frame, and updating the candidate point according to the plurality of previous frames, the current frame, and the motion vector comprises:
when a number of the plurality of previous frames is not less than a specified number and the first frame lacks a first keypoint associated with the object, performing a dynamic system prediction algorithm according to a plurality of historical keypoints associated with the object in the plurality of historical frames to update the candidate point.

13. The method for updating the keypoint in the object detection model of claim 12, wherein the plurality of historical frames comprises: a second frame preceding the first frame, a third frame preceding the second frame, and a fourth frame preceding the third frame, the second frame, the third frame, and the fourth frame each have a second keypoint, a third keypoint, and a fourth keypoint associated with the object, and performing the dynamic system prediction algorithm according to the plurality of historical keypoints associated with the object in the plurality of historical frames to update the candidate point comprises:
performing the dynamic system prediction algorithm according to the second keypoint, the third keypoint, and the fourth keypoint to generate the first keypoint; and
performing the dynamic system prediction algorithm according to the first keypoint, the second keypoint, the third keypoint, and the fourth keypoint to update the candidate point.

14. The method for updating the keypoint in the object detection model of claim 9, wherein the plurality of previous frames comprises a first frame preceding the current frame and a plurality of historical frames preceding the first frame, and updating the candidate point according to the plurality of previous frames, the current frame, and the motion vector comprises:
when a number of the plurality of previous frames is not less than a specified number and the first frame has a first keypoint associated with the object, performing a motion vector prediction procedure according to the first keypoint and the motion vector to generate a first update result and a statistical range;
performing a dynamic system prediction algorithm according to a plurality of historical keypoints associated with the object in the plurality of historical frames to generate a second update result;
when the second update result is outside the statistical range, updating the candidate point according to the first update result; and
when the second update result is within the statistical range, updating the candidate point according to the second update result.

15. The method for updating the keypoint in the object detection model of claim 14, wherein the plurality of historical frames comprises: a second frame preceding the first frame, a third frame preceding the second frame, and a fourth frame preceding the third frame; and performing the dynamic system prediction algorithm according to the plurality of historical keypoints associated with the object in the plurality of historical frames to generate the second update result comprises:
when one of the second frame and the third frame lacks the keypoint associated with the object, performing an interpolation according to the first keypoint associated with the object in the first frame, a second keypoint associated with the object in the second frame or a third keypoint associated with the object in the third frame, and a fourth keypoint associated with the object in the fourth frame to generate the keypoint;
performing the dynamic system prediction algorithm according to the first keypoint, the second keypoint, the third keypoint, and the fourth keypoint to generate the second update result.

16. The method for updating the keypoint in the object detection model of claim 14, wherein the plurality of historical frames comprises: a second frame preceding the first frame, a third frame preceding the second frame, and a fourth frame preceding the third frame, and performing the dynamic system prediction algorithm according to the plurality of historical keypoints associated with the object in the historical frames to generate the second update result comprises:
when the second frame has a second keypoint associated with the object and the third frame has a third keypoint associated with the object, performing the dynamic system prediction algorithm according to the second keypoint, the third keypoint, and a fourth keypoint associated with the object in the fourth frame to generate the second update result.
